(19) United States
(12) Patent Application Publication
(10) Pub. No.: US 2022/0357476 A1
(43) Pub. Date: Nov. 10, 2022

(54) INVERSION METHOD AND APPARATUS FOR MULTILAYER SEABED GEOACOUSTIC PARAMETER IN SHALLOW SEA, COMPUTER DEVICE AND STORAGE MEDIUM

(71) Applicant: ZHEJIANG OCEAN UNIVERSITY, Zhoushan (CN)

(72) Inventors: Hanhao Zhu, Zhoushan (CN); Yangyang Xue, Zhoushan (CN); Zhiqiang Cui, Zhoushan (CN); Qile Wang, Zhoushan (CN)

(21) Appl. No.: 17/588,224

(22) Filed: Jan. 29, 2022

Related U.S. Application Data
(63) Continuation of application No. PCT/CN2021/090789, filed on Apr. 29, 2021.

(51) Int. Cl. G01V 1/30; G01V 1/18; G01V 1/38

(52) U.S. Cl. CPC G01V 1/307; G01V 1/186; G01V 1/38; G01V 2210/63

(57) ABSTRACT

An inversion method for a multilayer seabed geoacoustic parameter in a shallow sea, includes: establishing a plurality of seabed models, different seabed models corresponding to different layer numbers, randomly generating a value of each geoacoustic parameter based on a preset change range corresponding to each geoacoustic parameter, then calculating to obtain a theoretical sound pressure value, and comparing the theoretical sound pressure value with an actual sound pressure value, adjusting and updating the value of each geoacoustic parameter according to the comparison result until the obtained theoretical sound pressure value is matched with the actual sound pressure value, and obtaining a target geoacoustic parameter value; calculating to obtain a BIC value corresponding to each seabed model; and taking the seabed model with the minimum BIC value as a target seabed model, and taking a target geoacoustic parameter value corresponding to the target seabed model as a target inversion parameter value.

### CROSS REFERENCE TO RELATED APPLICATIONS

The present application is a Continuation application of PCT Application No. PCT/CN2021/090789 filed on Apr. 29, 2021, the contents of which are incorporated herein by reference in their entirety.

### TECHNICAL FIELD

The present application relates to the field of computer technologies, and more particularly, to an inversion method and apparatus for a multilayer seabed geoacoustic parameter in a shallow sea, a computer device and a storage medium.

### BACKGROUND

Seabed geoacoustic parameters are one of the important parameters that make up a marine acoustic environment. Acoustic parameters such as seabed sound velocity, density and sound velocity attenuation have an important influence on acoustic propagation in a marine environment, especially in a shallow sea environment. Mastery of the above-mentioned seabed geoacoustic parameters will directly affect performance prediction and evaluation of underwater acoustic devices, numerical forecast of marine sound fields, utilization of marine sound field characteristics and the like. How to efficiently and accurately acquire seabed geoacoustic parameter information has always been a research hotspot in the underwater acoustic field.

At present, methods for acquiring seabed geoacoustic parameters comprise direct measurement and indirect measurement. Compared with the direct measurement method of acquiring seabed sediment samples by drilling and sampling, the indirect measurement method of geoacoustic parameters represented by acoustic inversion technology is widely used to acquire seabed geoacoustic parameters due to real-time, fast and efficient technical advantages thereof. Since conventional sonar works mostly on sound waves in middle/high frequency bands, most of the past inversion studies on seabed geoacoustic parameter focused on seabed surface acoustic characteristics, and it was assumed that the seabed was a liquid medium. In recent years, with the development of sonar devices to low frequency/very low frequency, previous understanding and mastery of the subsea surface acoustic characteristics can no longer meet analysis and verification on the current acoustic propagation problems. Therefore, it is increasingly urgent to carry out researches on deep seabed geoacoustic parameter inversion technologies including seabed structures. Moreover, the existing research achievements have proved that the influence of subsea sound velocity wave cannot be ignored when studying the geoacoustic propagation at low frequency/very low frequency. Therefore, in the current research of seabed geoacoustic parameter inversion problems, the seabed is regarded as a layered elastic medium, and performing accurate inversion on inner and deep geoacoustic parameters including layered structure, shear sound velocity and attenuation thereof is the current development goal of seabed geoacoustic parameters, and related research work needs to be carried out urgently.

Therefore, it is necessary to design a novel an inversion method for a multilayer seabed geoacoustic parameter in a shallow sea on the basis of the above-mentioned technical problems.

### SUMMARY

Based on this, it is necessary to provide an efficient and accurate an inversion method and apparatus for a multilayer seabed geoacoustic parameter in a shallow sea, a computer device and a storage medium in view of the above-mentioned problems.

An inversion method for a multilayer seabed geoacoustic parameter in a shallow sea comprises:

establishing a plurality of seabed models, different seabed models corresponding to different layer numbers, the geoacoustic parameter in each layer of each seabed model being a parameter to be inverted, and the geoacoustic parameter comprising: a density, a shear sound velocity, a longitudinal sound velocity, a shear attenuation, a longitudinal attenuation and a seabed thickness;

respectively acquiring a preset change range corresponding to each geoacoustic parameter with respect to each seabed model, randomly generating a value of each geoacoustic parameter based on the preset change range corresponding to each geoacoustic parameter, and then calculating to obtain a theoretical sound pressure value based on the value of each geoacoustic parameter;

acquiring an actual sound pressure value obtained by actual measurement;

comparing the theoretical sound pressure value with the actual sound pressure value, adjusting and updating the value of each geoacoustic parameter according to the comparison result, re-executing the step of calculating to obtain the theoretical sound pressure value based on the value of each geoacoustic parameter until the obtained theoretical sound pressure value is matched with the actual sound pressure value, and taking the value of each geoacoustic parameter corresponding to the matched theoretical sound pressure value as a target geoacoustic parameter value corresponding to the parameter to be inverted at the moment;

calculating to obtain a BIC value corresponding to each seabed model by a Bayesian theory according to the target geoacoustic parameter value corresponding to each seabed model; and

taking the seabed model with the minimum BIC value as a target seabed model, and taking a target geoacoustic parameter value corresponding to the target seabed model as a target inversion parameter value.

An inversion apparatus for a multilayer seabed geoacoustic parameter in a shallow sea comprises:

an establishing module, configured for establishing a plurality of seabed models, different seabed models corresponding to different layer numbers, the geoacoustic parameter in each layer of each seabed model being a parameter to be inverted, and the geoacoustic parameter comprising: a density, a shear sound velocity, a longitudinal sound velocity, a shear attenuation, a longitudinal attenuation and a seabed thickness;

a generating module, configured for respectively acquiring a preset change range corresponding to each geoacoustic parameter with respect to each seabed model, randomly generating a value of each geoacoustic parameter based on the preset change range corresponding to each geoacoustic parameter, and then calculating to obtain a theoretical sound pressure value based on the value of each geoacoustic parameter;

an acquisition module, configured for acquiring an actual sound pressure value obtained by actual measurement;

an updating module, configured for comparing the theoretical sound pressure value with the actual sound pressure value, adjusting and updating the value of each geoacoustic parameter according to the comparison result, re-executing the step of calculating to obtain the theoretical sound pressure value based on the value of each geoacoustic parameter until the obtained theoretical sound pressure value is matched with the actual sound pressure value, and taking the value of each geoacoustic parameter corresponding to the matched theoretical sound pressure value as a target geoacoustic parameter value corresponding to the parameter to be inverted at the moment;

a calculation module, configured for calculating to obtain a BIC value corresponding to each seabed model by a Bayesian theory according to the target geoacoustic parameter value corresponding to each seabed model; and

a determining module, configured for taking the seabed model with the minimum BIC value as a target seabed model, and taking a target geoacoustic parameter value corresponding to the target seabed model as a target inversion parameter value.

A computer device comprises a memory and a processor, wherein the memory stores a computer program which, when being executed by the processor, enables the processor to execute the following steps of:

establishing a plurality of seabed models, different seabed models corresponding to different layer numbers, the geoacoustic parameter in each layer of each seabed model being a parameter to be inverted, and the geoacoustic parameter comprising: a density, a shear sound velocity, a longitudinal sound velocity, a shear attenuation, a longitudinal attenuation and a seabed thickness;

respectively acquiring a preset change range corresponding to each geoacoustic parameter with respect to each seabed model, randomly generating a value of each geoacoustic parameter based on the preset change range corresponding to each geoacoustic parameter, and then calculating to obtain a theoretical sound pressure value based on the value of each geoacoustic parameter;

acquiring an actual sound pressure value obtained by actual measurement;

comparing the theoretical sound pressure value with the actual sound pressure value, adjusting and updating the value of each geoacoustic parameter according to the comparison result, re-executing the step of calculating to obtain the theoretical sound pressure value based on the value of each geoacoustic parameter until the obtained theoretical sound pressure value is matched with the actual sound pressure value, and taking the value of each geoacoustic parameter corresponding to the matched theoretical sound pressure value as a target geoacoustic parameter value corresponding to the parameter to be inverted at the moment;

calculating to obtain a BIC value corresponding to each seabed model by a Bayesian theory according to the target geoacoustic parameter value corresponding to each seabed model; and

taking the seabed model with the minimum BIC value as a target seabed model, and taking a target geoacoustic parameter value corresponding to the target seabed model as a target inversion parameter value.

A computer readable storage medium stores a computer program which, when being executed by a processor, enables the processor to execute the following steps of:

establishing a plurality of seabed models, different seabed models corresponding to different layer numbers, the geoacoustic parameter in each layer of each seabed model being a parameter to be inverted, and the geoacoustic parameter comprising: a density, a shear sound velocity, a longitudinal sound velocity, a shear attenuation, a longitudinal attenuation and a seabed thickness;

respectively acquiring a preset change range corresponding to each geoacoustic parameter with respect to each seabed model, randomly generating a value of each geoacoustic parameter based on the preset change range corresponding to each geoacoustic parameter, and then calculating to obtain a theoretical sound pressure value based on the value of each geoacoustic parameter;

acquiring an actual sound pressure value obtained by actual measurement;

comparing the theoretical sound pressure value with the actual sound pressure value, adjusting and updating the value of each geoacoustic parameter according to the comparison result, re-executing the step of calculating to obtain the theoretical sound pressure value based on the value of each geoacoustic parameter until the obtained theoretical sound pressure value is matched with the actual sound pressure value, and taking the value of each geoacoustic parameter corresponding to the matched theoretical sound pressure value as a target geoacoustic parameter value corresponding to the parameter to be inverted at the moment;

calculating to obtain a BIC value corresponding to each seabed model by a Bayesian theory according to the target geoacoustic parameter value corresponding to each seabed model; and

taking the seabed model with the minimum BIC value as a target seabed model, and taking a target geoacoustic parameter value corresponding to the target seabed model as a target inversion parameter value.

According to the above-mentioned inversion method and apparatus for the multilayer seabed geoacoustic parameter in the shallow sea, the computer device and the storage medium, firstly, the plurality of seabed models are established, different seabed models corresponding to different layer numbers; then, the value of each geoacoustic parameter is randomly generated with respect to each seabed model, and the theoretical sound pressure value is obtained by calculating based on the value of each geoacoustic parameter, the theoretical sound pressure value matched with the actual sound pressure value is determined by comparing the theoretical sound pressure value with the actual sound pressure value, so that the target geoacoustic parameter value corresponding to each seabed model is determined, and finally, the BIC value of each seabed model is obtained by calculating by the Bayesian theory, and the seabed model with the minimum BIC value is taken as the target seabed model. In the above process, the theoretical sound pressure value obtained by calculating is compared with the actual sound pressure value to obtain the target geoacoustic parameter value by inversion, and the BIC value is calculated by the Bayesian theory with respect to each seabed model, and the optimal seabed model structure is determined according to the BIC value. This method not only obtains the geoacoustic parameter value in the target seabed model effectively and accurately through inversion, but also determines the optimal layer number of the seabed model.

### BRIEF DESCRIPTION OF THE DRAWINGS

In order to illustrate the technical solutions in the embodiments of the present application or in the related art more clearly, the drawings used in the description of the embodiments or the prior art will be briefly described below. Obviously, the drawings in the following description are merely some embodiments of the present application. Those of ordinary skills in the art can also obtain other drawings based on these drawings without going through any creative effort.

Wherein:

FIG. 1 is a flowchart of an inversion method for a multilayer seabed geoacoustic parameter in a shallow sea in one embodiment;

FIG. 2 is a drawing of a multilayer subsea parameterized model in one embodiment;

FIG. 3 is a structural block diagram of an inversion apparatus for a multilayer seabed geoacoustic parameter in a shallow sea in one embodiment; and

FIG. 4 is an internal structure diagram of a computer device in one embodiment.

### DETAILED DESCRIPTION

Hereinafter, the technical solutions in the embodiments of the present application are illustrated clearly and completely with the accompanying drawings in the embodiments of the present application. Apparently, the described embodiments are merely some but not all of the embodiments of the present application. Based on the embodiments of the present application, all other embodiments obtained by those of ordinary skills in the art without going through any creative effort shall fall within the scope of protection of the present application.

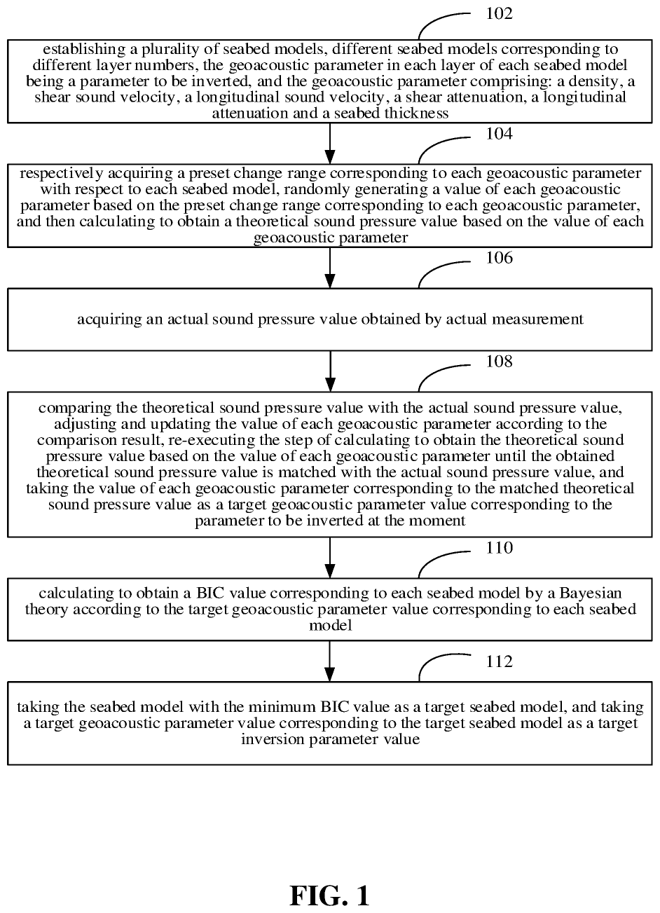

As shown in FIG. 1, an inversion method for a multilayer seabed geoacoustic parameter in a shallow sea is provided. The inversion method for the multilayer seabed geoacoustic parameter in the shallow sea may be applied to a terminal. In this embodiment, the method is illustrated by being applied to the terminal. The inversion method for the multilayer seabed geoacoustic parameter in the shallow sea specifically comprises the following steps.

At step 102, a plurality of seabed models are established, different seabed models corresponding to different layer numbers, the geoacoustic parameter in each layer of each seabed model being a parameter to be inverted, and the geoacoustic parameter comprising: a density, a shear sound velocity, a longitudinal sound velocity, a shear attenuation, a longitudinal attenuation and a seabed thickness.

Establishing the plurality of different seabed models is to find out the optimal seabed model which is consistent with an actual situation subsequently. Different seabed models have different layer numbers, that is, different seabed models have different seabed structures. The seabed model is established on the basis of a wave theory, and the established seabed model is expressed by an equation. The equation of the established seabed model relates to the geoacoustic parameter and a sound pressure, that is, the geoacoustic parameter and the sound pressure are parameters in the seabed model. In order to get a more accurate seabed model, the geoacoustic parameter in this application is comprehensive, and a plurality of factors such as the density, the shear sound velocity, the longitudinal sound velocity, the shear attenuation, the longitudinal attenuation and the seabed thickness are considered in each layer.

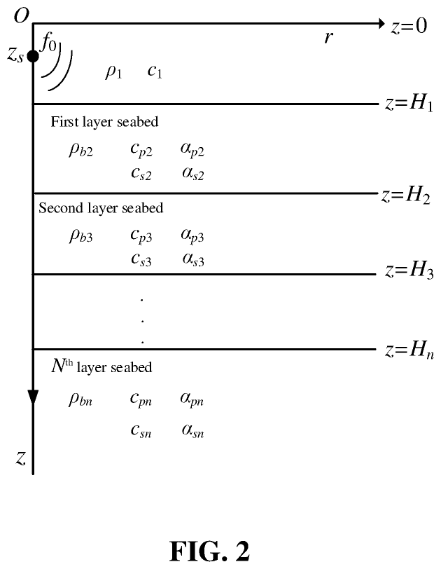

Seabed models with different layer numbers are different, and the calculation processes thereof are also different. The more the layers of the seabed are, the more parameters needing to be inverted are. The model is divided horizontally. For each layer of seabed added, four equations will be added in the calculation process. FIG. 2 is a drawing of a multilayer subsea parameterized model, wherein each layer contains a corresponding geoacoustic parameter. In the drawing, cₚ, cₛ, ρ_{b}, αₚ and αₛ respectively denote a longitudinal sound velocity, a shear sound velocity, a seabed density, a longitudinal sound velocity attenuation and a shear wave sound velocity attenuation, z denotes a water depth, zₛ denotes a sound source depth, r denotes a propagation length, f₀ denotes a sound source frequency, and the subscripts respectively denote the layer numbers located.

At step 104, a preset change range corresponding to each geoacoustic parameter is respectively acquired with respect to each seabed model, a value of each geoacoustic parameter is randomly generated based on the preset change range corresponding to each geoacoustic parameter, and then a theoretical sound pressure value is obtained by calculating based on the value of each geoacoustic parameter.

The preset change range of each geoacoustic parameter refers to a preset change range of the value of the geoacoustic parameter. Because the geoacoustic parameter and the sound pressure are unknown parameters in the seabed model equation, and there are many geoacoustic parameters, the equation cannot be solved directly. Here, the value of the geoacoustic parameter is inversed through a process of constant optimization by assigning a value to each geoacoustic parameter. The value assigning method is that a corresponding geoacoustic parameter value is randomly generated for each geoacoustic parameter within the preset change range, and then the sound pressure value, that is, the theoretical sound pressure value, can be obtained by calculating based on the value of value of each geoacoustic parameter. The change range of each geoacoustic parameter can be customized according to the actual situations. In one embodiment, the preset change range is set as follows: density g·cm⁻³ (1 to 2), longitudinal sound velocity (1,800 to 2,000), shear sound velocity (900 to 1,100), longitudinal attenuation dB/λ (0.09 to 0.11), shear attenuation dB/λ (0.09 to 0.11), and thickness (several tens of meters ranging from 15 to 25). Then, the value of the geoacoustic parameter is generated on the basis of the preset range, such as: density (1.5), longitudinal sound velocity (1,950), shear sound velocity (900), longitudinal attenuation (0.095), shear attenuation (0.096) and seabed thickness (18).

At step 106, an actual sound pressure value obtained by actual measurement is acquired.

The actual sound pressure value can be measured by the hydrophone. The hydrophone monitors the sound wave emitted by the sound source, and then processes the monitored sound wave to obtain the actual sound pressure value. In one embodiment, the result measured by the hydrophone is an audio in way format, which is imported into matlab and converted into a numerical form. Then, a frequency spectrum of this set of data is obtained by Fourier transform, and an amplitude of the frequency spectrum is the sound pressure value. Generally, the actual sound pressure value obtained is composed of one set of sound pressure values, for example, one set of sound pressure values contains 1,000 numerical values.

At step 108, the theoretical sound pressure value is compared with the actual sound pressure value, the value of each geoacoustic parameter is adjusted and updated according to the comparison result, and the step of calculating to obtain the theoretical sound pressure value based on the value of each geoacoustic parameter is re-executed until the obtained theoretical sound pressure value is matched with the actual sound pressure value, and the value of each geoacoustic parameter corresponding to the matched theoretical sound pressure value is taken as a target geoacoustic parameter value corresponding to the parameter to be inverted at the moment.

An error value between the theoretical sound pressure value and the actual sound pressure value is calculated by using an error function. When the theoretical sound pressure value is not matched with the actual sound pressure value, the value of each geoacoustic parameter needs to be updated within the preset range of each geoacoustic parameter to calculate the theoretical sound pressure value again and then compare the theoretical sound pressure value with the actual sound pressure value until the calculated theoretical sound pressure value is matched with the actual sound pressure value through repeated iterative calculations in this way.

There are many ways to judge whether the theoretical sound pressure value is matched with the actual sound pressure value. One is to set a minimum error value in advance, and judge whether the two values are matched when the error between the two is less than the minimum error value. One is that after multiple iterations, the error value converges, then the iteration is stopped, and the finally obtained theoretical sound pressure value is taken as the sound pressure value matched with the actual sound pressure value, and then the value of each geoacoustic parameter corresponding to the matched theoretical sound pressure value is taken as the target geoacoustic parameter value corresponding to the parameter to be inverted. The target geoacoustic parameter value is the value of the geoacoustic parameter obtained by inversion.

For the multilayer seabed model mentioned above, the theoretical sound pressure value is calculated by assigning a value to each geoacoustic parameter, and the inversion of each geoacoustic parameter is realized by comparing the theoretical sound pressure value with the actual sound pressure value. In the multilayer seabed model, the method of comparing the theoretical sound pressure value with the actual sound pressure value is used to invert each geoacoustic parameter, so that the value of each geoacoustic parameter can be determined efficiently and accurately.

At step 110, a BIC value corresponding to each seabed model is obtained by calculating by a Bayesian theory according to the target geoacoustic parameter value corresponding to each seabed model.

The introduction of BIC (Bayesian Information Criterion) is to discriminate how the marine environment where the actual sound pressure locates is stratified. Since one set of actual sound pressure data is measured, the corresponding target geoacoustic parameter can be calculated for different seabed models. However, which seabed model is the best? Here, the BIC value of each seabed model is innovatively calculated based on BIC criterion, and determine the optimal target geoacoustic parameter obtained by the inversion of the seabed model by comparing the BIC values.

At step 112, the seabed model with the minimum BIC value is taken as a target seabed model, and a target geoacoustic parameter value corresponding to the target seabed model is taken as a target inversion parameter value.

The smaller the BIC value is, the closer the seabed model is to the real seabed environment. The obtained target geoacoustic parameter value corresponding to the target seabed model is taken as the target inversion parameter value of the geoacoustic parameter (i.e., target inversion result).

According to the above-mentioned inversion method for the multilayer seabed geoacoustic parameter in the shallow sea, firstly, the plurality of seabed models are established, different seabed models corresponding to different layer numbers; then, the value of each geoacoustic parameter is randomly generated with respect to each seabed model, and the theoretical sound pressure value is obtained by calculating based on the value of each geoacoustic parameter, the theoretical sound pressure value matched with the actual sound pressure value is determined by comparing the theoretical sound pressure value with the actual sound pressure value, so that the target geoacoustic parameter value corresponding to each seabed model is determined, and finally, the BIC value of each seabed model is obtained by calculating by the Bayesian theory, and the seabed model with the minimum BIC value is taken as the target seabed model. In the above process, the theoretical sound pressure value obtained by calculating is compared with the actual sound pressure value to obtain the target geoacoustic parameter value by inversion, and the BIC value is calculated by the Bayesian theory with respect to each seabed model, and the optimal seabed model structure is determined according to the BIC value. This method not only obtains the geoacoustic parameter value in the target seabed model effectively and accurately through inversion, but also determines the optimal layer number of the seabed model.

In one embodiment, the step of establishing the plurality of seabed models, different seabed models corresponding to different layer numbers, comprises: according to a wave theory, constructing a displacement potential functional equation corresponding to each layer in each seabed model; and calculating to obtain a general solution of each displacement potential function according to the displacement potential function equation, the general solution of each displacement potential function containing a plurality of uncertain coefficients, the plurality of uncertain coefficients being related to the geoacoustic parameter, and the theoretical sound pressure value is obtained by calculating according to the displacement potential function.

In cylindrical coordinates, the physical quantities of the seabed of each layer are represented by the displacement potential function, and the establishment of the displacement potential function of each layer satisfies a wave equation system. The displacement potential function of each layer can be represented in combination with a point source condition and a boundary condition at a fluid/elastomer interface under a sound field condition. Then, according to the Fast Field Method (FFM), in fact, each coefficient of the equation system is solved, so that the displacement potential function of each layer is obtained. Then, the sound pressure value of each point in the fluid layer can be obtained by using a relationship between the sound pressure p and the potential function ϕ₁ that p=ρ₁ω²ϕ₁ in the fluid layer.

The establishment of the seabed model and the derivation of the sound pressure calculation formula are as follows: according to the wave theory, in a frequency domain, the displacement potential function of each layer in the multilayer seabed model satisfies the following equations:

$$\frac{1}{r} \frac{\partial }{\partial r} ( r \frac{\partial {ϕ}_{1}}{\partial r} ) + \frac{{\partial }^{2} {ϕ}_{1}}{\partial {z}^{2}} + {k}_{1}^{2} {ϕ}_{1} = - 4 πδ ( r , z - {z}_{s} ) 0 \leq z < {H}_{1} \qquad ( 1 )$$

$$\{ \begin{matrix}\frac{1}{r} \frac{\partial }{\partial r} ( r \frac{\partial {ϕ}_{pn}}{\partial r} ) + \frac{{\partial }^{2} {ϕ}_{pn}}{\partial {z}^{2}} + {k}_{pn}^{2} {ϕ}_{pn} = 0 \\ ∇ \times ∇ \times {ψ}_{sn} - {k}_{sn}^{2} {ψ}_{sn} = 0\end{matrix} {H}_{n} \leq z < {H}_{n + 1} n \geq 1 \qquad ( 2 )$$

$$\{ \begin{matrix}\frac{1}{r} \frac{\partial }{\partial r} ( r \frac{\partial {ϕ}_{pN}}{\partial r} ) + \frac{{\partial }^{2} {ϕ}_{pN}}{\partial {z}^{2}} + {k}_{pN}^{2} {ϕ}_{pN} = 0 \\ ∇ \times ∇ \times {ψ}_{sN} - {k}_{sN}^{2} {ψ}_{sN} = 0\end{matrix} z \geq {H}_{N} \qquad ( 3 )$$

wherein, δ(r, z) denotes a sound source equation, kₘₙ=Ω/cₘ (m=1, p, s n=1 . . . N) denotes a wave number of each layer, ω=2πf₀ denotes an angular frequency of the point source at f₀, and r denotes a signal propagation length; z denotes a vertical depth; V denotes Laplace operator; ϕ₁ denotes the displacement potential function in the fluid layer; ϕₚ denotes a median scalar displacement potential function of an elastic seabed, and ψₛ denotes a vector displacement potential function; k₁=ω/c₁ denotes a wave number in the fluid layer, kₚ=ω/cₚ′ denotes a longitudinal wave number in the elastic seabed (cₚ′ is a sound velocity value after adding sound velocity attenuation, wherein

$${c}_{p}^{′} = \frac{{c}_{p}}{1 + i \frac{{α}_{p}}{40 π \cdot {log}_{10} ( e )}} ) ,$$

and kₛ=Ω/cₛ′ denotes a transverse wave number in the elastic seabed; ω=2πf₀ denotes an angular frequency corresponding to a sound source frequency f₀. The establishment of the seabed model is based on the wave theory, which is reliable.

In one embodiment, the step of acquiring the actual sound pressure value obtained by actual measurement, comprises: using a hydrophone to monitor a sound wave emitted by a sound source, wherein the sound wave is generated by transmitting in water by a transmitting transducer, and the hydrophone and the transmitting transducer complete the measurement by relative movement; importing an audio in way format detected by the hydrophone into matlab and converting the audio into one set of numerical values; processing the one set of numerical values by Fourier transform to obtain a frequency spectrum corresponding to the one set of numerical values; and calculating an amplitude of the frequency spectrum to obtain the actual sound pressure value, wherein the actual sound pressure value comprises sound pressure values of a plurality of positions.

Way is a sound file format. Matlab is mathematical software, which is used for data analysis and the like.

In general, an actual marine environment refers to low frequency signals generally around 100 HZ, so that the propagation length will be further to achieve the purpose of carrying more submarine information, and a launching position may be several meters or tens of meters underwater. When this method is actually used at sea, the hydrophone or sound source is carried by a vessel to move generally. In other words, a position of the sound source is fixed, and the trial vessel carries the hydrophone to move to complete the measurement. Alternatively, a position of the hydrophone is fixed, and the trial vessel carries the sound source to move to complete the measurement. The transmitting transducer is a sound source device in the experiment, through which the sound waves can be transmitted into the water. In theoretical writing and analysis, the sound source will be used to describe. A sound generating device in the experiment is the transmitting transducer. In practice, power supply ends of the transmitting transducer and the hydrophone are usually fixed on vessel, and transmitting and receiving ends thereof are lowered into the water through cables to a depth that is determined according to the experimental design. The measured audio in way format is imported into the matlab and converted into the numerical form. After Fourier transform, the frequency spectrum of this set of data is obtained, and an amplitude of the frequency spectrum is the sound pressure value. When measuring, it is impossible to measure the sound pressure at one position only, but to measure the sound pressures at different positions by carrying the hydrophone or sound source by the vessel to move, thus obtaining one set of sound pressure values. The above-mentioned actual sound pressure values are measured based on the actual marine environment, and one set of sound pressure values are measured, which are reliable and accurate.

A laboratory anechoic tank experiment is taken as an example. A board made of polyvinyl chloride material is used to simulate the seabed. A high-frequency underwater sound is emitted by a sound source at a fixed position, and a receiving hydrophone measures once every fixed distance. A transmitting transducer is fixed in water at one end, and the receiving hydrophone is fixed on a mobile miniature workbench. The workbench moves 2 mm each time, and a measurement error is less than 20 μm. A computer is used to control the mobile workbench to measure and acquire data. When the measurement in one position is completed, the workbench automatically moves to next position, and measures 1,000 points in total.

In one embodiment, the step of, comparing the theoretical sound pressure value with the actual sound pressure value, and adjusting and updating the value of each geoacoustic parameter according to the comparison result, comprises: calculating an error value between the theoretical sound pressure value and the actual sound pressure value by an error function, wherein a formula of the error function is as follows:

$$E ( m ) = K {\sum }_{f = 1}^{F} In [ {B}^{f} ( m ) {\vert {p}_{mea}^{f} \vert}^{2} ] ;$$

wherein

$${B}^{f} ( m ) = 1 - \frac{{\vert {[ {p}_{FFM}^{f} ( m ) ]}^{*} {p}_{mea}^{f} \vert}^{2}}{{\vert {p}_{mea}^{f} \vert}^{2} {\vert {p}_{FFM}^{f} ( m ) \vert}^{2}} ,$$

P_{FFM}^{f}(m) denotes the theoretical sound pressure value, Pₘₑₐ^{f} denotes the actual sound pressure value, and m denotes the parameter of the seabed model; * denotes conjugate transpose, f denotes a serial number of frequency points, F denotes a total number of frequency points used, and K denotes a number of hydrophones. When the error value is greater than a preset error value, the value of each geoacoustic parameter is updated and adjusted.

The error value between the theoretical sound pressure value and the actual sound pressure value is calculated by the error function. The error function is designed by the Bayesian theory. Under the Bayesian theory, an error function of the relationship between the theoretical sound pressure and the actual sound pressure is established by combining a likelihood function. Under this theory, when the error function reaches a minimum value, it is indicated that the similarity between the theoretical sound pressure and the actual sound pressure reaches maximum, that is, the theoretical sound pressure in this case is equal to the actual sound pressure. The error function can accurately reflect a difference between the theoretical sound pressure value and the actual sound pressure value, so as to better match to obtain the theoretical sound pressure value matched with the actual sound pressure value.

In one embodiment, the step of, respectively acquiring the preset change range corresponding to each geoacoustic parameter with respect to each seabed model, randomly generating the value of each geoacoustic parameter based on the preset change range corresponding to each geoacoustic parameter, and then calculating to obtain the theoretical sound pressure value based on the value of each geoacoustic parameter in combination with the displacement potential function of each layer of the seabed model, comprises: acquiring an initial value of each geoacoustic parameter, wherein the initial value is randomly generated based on the preset change range; performing disturbance by using the improved simulated annealing method to generate the new value of each geoacoustic parameter based on the initial value of each geoacoustic parameter and the preset change range; and calculating to obtain a corresponding new theoretical sound pressure value according to the new value of each geoacoustic parameter.

The step of, comparing the theoretical sound pressure value with the actual sound pressure value, adjusting and updating the value of each geoacoustic parameter according to the comparison result, and re-executing the step of calculating to obtain the theoretical sound pressure value based on the current value of each geoacoustic parameter until the obtained theoretical sound pressure value is matched with the actual sound pressure value, comprises: calculating to obtain a new error value according to the new theoretical sound pressure value and the actual sound pressure value, comparing the new error value with the previous error value, retaining a smaller error value and a corresponding geoacoustic parameter, re-executing the step of generating the new geoacoustic parameter value by performing disturbance based on the initial value of each geoacoustic parameter and the preset change range until a convergence condition is reached, and taking the theoretical sound pressure value corresponding to the value of each finally retained geoacoustic parameter as a sound pressure value matched with the actual sound pressure value.

The process of determining the theoretical sound pressure value matched with the actual sound pressure value is the inversion process of the geoacoustic parameter. Firstly, the preset change range of each geoacoustic parameter is set, and then the geoacoustic parameter is initialized. The process of initializing the geoacoustic parameter refers to randomly generating the initial value of each geoacoustic parameter within the preset change range. Then, each initial value is substituted into the seabed model to calculate the theoretical sound pressure value, and the theoretical sound pressure value and the actual sound pressure value are substituted into the error function to obtain the error value. The error value is used to measure the difference between the theoretical sound pressure value and the actual sound pressure value. The smaller the error value is, the closer the theoretical sound pressure value and the actual sound pressure value are. Then, a disturbance algorithm is adopted to generate new values in a preset range through disturbance with the initial value as the center to obtain the new value of each geoacoustic parameter, and then a new theoretical sound pressure value is obtained by calculating. The new theoretical sound pressure value and the actual sound pressure value are calculated by the error function to obtain a new error value. The new error value is compared with the initial error value, and the smaller error value and the geoacoustic parameter value are retained. Then, the disturbance algorithm is adopted to repeatedly generate new values in the preset range through disturbance with the initial value as the center to obtain the new value of each geoacoustic parameter, and then the new theoretical sound pressure value is obtained by calculating. The new error value is compared with the retained error value, and then the theoretical sound pressure value with smaller error value and the corresponding geoacoustic parameter are retained until reaching convergency. The finally obtained value of the geoacoustic parameter corresponding to the theoretical sound pressure value is taken as the value obtained by inversion. In the above-mentioned process of assigning the value to each geoacoustic parameter, a preset change range is set for each geoacoustic parameter, thus ensuring that the randomly generated geoacoustic parameter will not deviate from the reality, and also ensuring randomness, thus accurately determining the value of the target geoacoustic parameter.

In one embodiment, the step of, performing disturbance by using the improved simulated annealing method to generate the new value of each geoacoustic parameter based on the initial value of each geoacoustic parameter and the preset change range, comprises: acquiring a current number of iterations, and determining a disturbance coefficient according to the current number of iterations; acquiring a disturbance condition, wherein the disturbance condition is that middle and lower seabed parameters in the multilayer seabed models are larger than upper seabed parameters; and randomly generating the new value of each geoacoustic parameter according to the preset change range, the disturbance coefficient and the disturbance condition.

The number of iterations determines a random disturbance amplitude. The number of iterations is inversely related to a disturbance amplitude, and the number of iterations is inversely related to a simulated annealing temperature. The lower the simulated annealing temperature is, the higher the number of iterations is, and the smaller the corresponding disturbance amplitude is. The disturbance condition is that the middle and lower seabed parameters in the multilayer seabed models are larger than the upper seabed parameters. An objective law that an acoustic impedance of the multi-sediment seabed increases with the increase of depth in general is effectively followed by setting the disturbance condition. Each geoacoustic parameter in the multilayer seabed model can follow the objective law by setting the disturbance condition, which is conducive to generating an accurate value of the geoacoustic parameter.

In one embodiment, the calculation of the disturbance process is as follows:

Step 1: a preset change range (i.e., upper and lower boundaries) is set for a parameter to be inverted, the results after performing disturbance by the algorithm are all remained in this range, and parameter values beyond this range will be eliminated by an out-of-range function; an initial temperature Tmax, an end temperature Tmin (i.e., an outer loop end condition is set) and a length L of Markov chain are set, which are used to denote an initial set number of population, i.e., study how many sets, for example, a number of population of 1,000 is set for the longitudinal sound velocity. In other words, 1,000 longitudinal sound velocities are optimized during each disturbance.

Step 2: an initial value is randomly generated for each parameter, wherein m₀ denotes the initial value of the parameter to be inverted, and Sₘᵢₙ denotes a lower boundary of each parameter interval; S_{L} denotes a parameter interval width, that is, the upper boundary minus the lower boundary; and rand (0,1) is a matlab function, which can generate a random number between 0 and 1.

m₀=Sₘᵢₙ+S_{L}−rand(0,1)

Step 3: the generated initial value is substituted into the seabed model to calculate the error value corresponding to this set of parameters and retain E(mᵢ).

Step 4: based on the initial value, a new solution is generated by disturbance, a function randi ( ) is introduced, and let R=randi ([0,1]), so that the value of R is either 0 or 1.

When R=0, shift to the left on the basis of the initial value, i.e.:

m_{new}=m_{now}+(Sₘₐₓ−m_{now})·a

wherein, m_{new} denotes the new solution after disturbance, m_{now} denotes the current solution (the initial solution in the first circulation), Sₘₐₓ denotes the upper boundary of the parameter interval, and a represents the disturbance coefficient. a=(1−rand(0,1)\hat{ }(1−(t/T)\hat{ }b)), wherein t denotes the current number of iterations, T denotes the preset total number of iterations, b controls a search step length, and an empirical value of b is generally 2. With the gradual decrease of the temperature, the value of t is increasing, that is, the value of a keeps a larger value when the temperature is higher and a smaller value when the temperature is lower, which can ensure a larger amount of disturbance in the initial search, and a search interval gradually decreases with the decrease of the temperature until the algorithm converges finally.

On the contrary, move to the right, i.e.:

m_{new}=m_{now}−(m_{now}−Sₘᵢₙ)·a

Step 5: the new solution after disturbance is substituted into the seabed model to calculate a new error value E(mᵢ), and make a difference with the previous error value to obtain ΔE=E(mᵢ₊₁)−E(mᵢ). A value of ΔE is judged; if ΔE is less than 0, the new solution is accepted; if ΔE is larger than 0, the new solution is accepted according to Metropolis criterion (accepting a new state with probability); if ΔE is neither less than nor greater than 0, the new solution is not accepted, and the original parameter solution is retained for comparing error values next time.

At step 6: it is determined whether an inner loop end condition is met (whether the error value converges); if not, return to step 4; if so, it is determined whether the outer loop end condition is met (whether the temperature is less than Tmin); if not, perform cooling, and if so, end the calculation and output the result.

For example: these parameters are substituted into a forward seabed model (that is, calculating the theoretical sound pressure) to obtain one set of sound pressures, which is one set of numbers with the same dimension as the actual sound pressure. For example, the actually measured sound pressure values are a set of sound pressure values of 1,000 points, and the theoretically calculated sound pressure values are also sound pressure values of 1,000 points. The theoretical sound pressure and the actual sound pressure are substituted into the error function to obtain an error value, such as −5, and then one set of values comprising 1.5, 2,000, 1,000, 0.01, 0.01 and 20 is given after disturbance. This set of parameters is into substituted the forward seabed model again to calculate the theoretical sound pressure, and the obtained theoretical sound pressure and the constant actual sound pressure are substituted into the error function to calculate an error value, such as −6. Because −6 is smaller, the set of parameters comprising 1.5, 2,000, 1,000, 0.01, 0.01 and 20 is better. Then, this set of parameters and the error value are saved.

The calculation below repeats the above steps, and next error value is compared with the saved error value −6. If the difference is −7, then the new set of parameters and error value are saved; if the difference is −3, then the previous set of parameters (−6) are retained still. In this way, the process is cycled until the error value remains unchanged, then the calculation is ended, and the last generation of parameter is retained as the inversion solution.

In one embodiment, the step of, calculating to obtain the BIC value corresponding to each seabed model by the Bayesian theory according to the target geoacoustic parameter value corresponding to each seabed model, comprises: calculating to obtain the BIC value corresponding to each seabed model by the Bayesian theory according to the target geoacoustic parameter value corresponding to each seabed model and the error value, wherein the calculating of the BIC value is realized by the following formula:

BIC=2E(\hat{m})+M logₑ^{N}

wherein, M is a number of parameters in the model, N is a number of data, and E(\hat{m}) denotes an error value calculated according to an error function.

The calculation formula of the BIC value is obtained by derivation, and a size of the BIC value is together determined by the error function, the number of model parameters and the number of data, thus avoiding under-parametric and over-parametric models and selecting the optimal seabed model more effectively.

In one embodiment, the Bayesian theory, the error function and the BIC formula are derived as follows:

random variables d and m respectively denote experimental data and a parameter of a seabed model extracted in a scaling experiment, and N and M respectively denote a number of the vector d and a number of the vector m. The vectors d and m satisfy the Bayesian theory:

P(m|d)=P(d|m)P(m)/P(d) (10)

wherein, P(m|d) is a posteriori probability density (PPD), a conditional probability P(d|m) of d is usually denoted by a likelihood function L(m), P(m) is a prior probability density function of m, and denotes available model parameter prior information independent of the data, and P(d) is a probability density function of the parameter d. Since P(d) is irrelevant to the parameter m, and may be regarded as a constant, the above formula may be modified into:

P(m|d)∝L(m)P(m) (11)

The likelihood function is determined by a data form and statistical distribution of data errors. Considering that it is difficult to independently obtain statistical characteristics of the errors during practical application, an assumption of unbiased Gaussian error is adopted during the processing procedure, and a form of the likelihood function is:

L(m)=P(d|m)∝ exp[−E(m)] (12)

wherein, E(m) is an error function, and after normalization, the following formula may be obtained:

$$P ( m \vert d ) = \frac{exp [ - E ( m ) ] P ( m )}{\int exp [ - E ( {m}^{′} ) ] P ( {m}^{′} ) {dm}^{′}} \qquad ( 13 )$$

wherein an integral domain spans an M-dimensional parameter space, and M is a number of parameters to be inverted. In the Bayesian theory, the posterior probability density (PPD) may be used as a solution of an inversion problem. Due to a problem of multi-dimensional parameter in inversion, in order to more reasonably explain parameter inversion results, it is necessary to study correlation characteristics among model parameters, such as a MAP value, a mean value and one-dimensional probability density distribution of the parameters, which are respectively defined as:

\hat{m}=Argₘₐₓ{P(m|d)} (14)

m̅=∫m′P(m′|d)dm′ (15)

P(mᵢ|d)=∫δ(mᵢ−mᵢ′)P(m′|d)dm′ (16)

In the Bayesian inversion theory, it is necessary to obtain the likelihood function L(m) to solve the parameter PPD, and the likelihood function is related to statistical distribution of the data errors (comprising a measurement error and a theoretical error), and is an important index to quantitatively describe parameter uncertainty. Assuming that the data error herein is an independent identically distributed random variable, the likelihood function may be represented as:

$$L ( m ) = {\prod }_{f = 1}^{F} \frac{1}{{π}^{K} \vert {C}_{m}^{f} \vert} exp \{ - {[ {p}_{mea}^{f} - {p}_{pre}^{f} ( m ) ]}^{T} {( {C}_{m}^{f} )}^{- 1} [ {p}_{mea}^{f} - {P}_{pre}^{f} ( m ) ] \} \qquad ( 17 )$$

wherein, p^{f}ₘₑₐ denotes a measured sound pressure received by a single sensor at a position k under a frequency f, and under the same condition, p^{f}ₚᵣₑ and C^{f}ₘ respectively denote a predicted sound pressure of the model and a covariance matrix.

The predicted sound pressure p^{f}ₚᵣₑ may be represented by the following formula:

p^{f}ₚᵣₑ(m)=A^{f}e^{iθ}^{_{f}}p_{FFM}^{f}(m) (18)

wherein p^{f}_{FFM} represents a sound pressure calculated by a fast field method (FFM), and A^{f} and θ^{f} are an amplitude and a phase of an unknown sound source at each frequency. Let ∂L(m)/∂A^{f}=∂L(m)/∂θ^{f}=0, a maximum likelihood estimate of the sound source may be obtained as follows:

$${A}^{f} {e}^{i {θ}^{f}} = \frac{{[ {p}_{FFM}^{f} ( m ) ]}^{*} {p}_{mea}^{f}}{{\vert {p}_{FFM}^{f} ( m ) \vert}^{2}} \qquad ( 19 )$$

wherein, * denotes conjugate transpose. Ignoring the spatial correlation of data, a diagonal covariance is approximately processed as C^{f}ₘ=ν^{f}I, wherein the variance ν_{f} is only related to the frequency, and I is a unit matrix. In this case, the likelihood function may be simplified as:

$$L ( m ) = {\prod }_{f = 1}^{F} \frac{1}{{( π {v}^{f} )}^{K}} exp [ - \frac{{B}^{f} ( m ) {\vert {p}_{mea}^{f} \vert}^{2}}{{v}^{f}} ] \qquad ( 20 )$$

wherein, B^{f}(m) denotes a normalized Bartlett adapter.

$${B}^{f} ( m ) = 1 - \frac{\vert {[ {p}_{FFM}^{f} ( m ) ]}^{*} {p}_{mea}^{f} {\vert}^{2}}{{\vert {p}_{mea}^{f} \vert}^{2} {\vert {p}_{FFM}^{f} ( m ) \vert}^{2}} \qquad ( 21 )$$

Let ∂L(m)/∂ν^{f}=0, a maximum likelihood estimator of the variance V is obtained, which is:

$${\hat{v}}_{f} = \frac{{B}^{f} ( m ) {\vert {p}_{mea}^{f} \vert}^{2}}{K} \qquad ( 22 )$$

When substituting the Formula (22) into the Formula (12) and the Formula (20), a corresponding error function E(m) satisfying the maximum likelihood estimator is obtained.

$$E ( m ) = K {\sum }_{f = 1}^{F} In [ {B}^{f} ( m ) {\vert {p}_{mea}^{f} \vert}^{2} ] \qquad ( 23 )$$

A reasonable under-parametric model is the key of Bayesian inversion, and an under-parametric model makes a structure unable to be fully analyzed, which decreases the uncertainty of the model. An over-parametric model has insufficient constraint on the parameters, which increases the uncertainty of the model. Both the under-parametric and over-parametric models may have certain influences on the inversion results. The Bayesian information criterion (BIC) is applied herein to select the parametric model most suitable for the measured data. The BIC value is obtained from normal distribution of the multi-dimensional variables, and is asymptotic approximation of the Bayesian theory P(d|I) of the model I instead of an exact value. In other words, assuming that the data d is measured, a likelihood function of the model I has an expression as follows:

−2 log P(d|I)≈BIC=−2 logₑ L(\hat{m})+M logₑ^{N} (24)

wherein M is a number of parameters in the model I, N is a number of data parameters. Replacing the likelihood function by the error function may obtain:

BIC=2E(\hat{m})+M logₑ^{N} (25)

The model with the minimum BIC value is the optimal model. It can be seen from the formula (25) that the size of the BIC value is together determined by the error function, the number of model parameters and the number of data, thus avoiding under-parametric and over-parametric models and selecting the optimal seabed model more effectively.

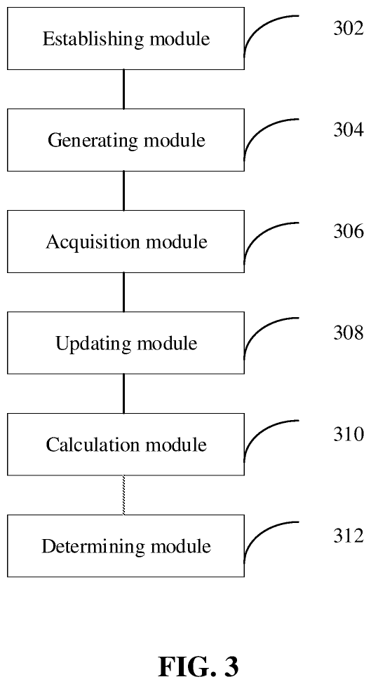

As shown in FIG. 3, an inversion apparatus for a multilayer seabed geoacoustic parameter in a shallow sea comprises:

an establishing module 302, configured for establishing a plurality of seabed models, different seabed models corresponding to different layer numbers, the geoacoustic parameter in each layer of each seabed model being a parameter to be inverted, and the geoacoustic parameter comprising: a density, a shear sound velocity, a longitudinal sound velocity, a shear attenuation, a longitudinal attenuation and a seabed thickness;

a generating module 304, configured for respectively acquiring a preset change range corresponding to each geoacoustic parameter with respect to each seabed model, randomly generating a value of each geoacoustic parameter based on the preset change range corresponding to each geoacoustic parameter, and then calculating to obtain a theoretical sound pressure value based on the value of each geoacoustic parameter;

an acquisition module 306, configured for acquiring an actual sound pressure value obtained by actual measurement;

an updating module 308, configured for comparing the theoretical sound pressure value with the actual sound pressure value, adjusting and updating the value of each geoacoustic parameter according to the comparison result, re-executing the step of calculating to obtain the theoretical sound pressure value based on the value of each geoacoustic parameter until the obtained theoretical sound pressure value is matched with the actual sound pressure value, and taking the value of each geoacoustic parameter corresponding to the matched theoretical sound pressure value as a target geoacoustic parameter value corresponding to the parameter to be inverted at the moment;

a calculation module 310, configured for calculating to obtain a BIC value corresponding to each seabed model by a Bayesian theory according to the target geoacoustic parameter value corresponding to each seabed model; and

a determining module 312, configured for taking the seabed model with the minimum BIC value as a target seabed model, and taking a target geoacoustic parameter value corresponding to the target seabed model as a target inversion parameter value.

In one embodiment, the establishing module 302 is further configured for, according to a wave theory, constructing a displacement potential functional equation corresponding to each layer in each seabed model; and calculating to obtain a general solution of each displacement potential function according to the displacement potential function equation, the general solution of each displacement potential function containing a plurality of uncertain coefficients, the plurality of uncertain coefficients being related to the geoacoustic parameter, and the theoretical sound pressure value is obtained by calculating according to the displacement potential function.

In one embodiment, the acquisition module 306 is further configured for using a hydrophone to monitor a sound wave emitted by a sound source, wherein the sound wave is generated by transmitting in water by a transmitting transducer, and the hydrophone and the transmitting transducer complete the measurement by relative movement; importing an audio in way format detected by the hydrophone into matlab and converting the audio into one set of numerical values; processing the one set of numerical values by Fourier transform to obtain a frequency spectrum corresponding to the one set of numerical values; and calculating an amplitude of the frequency spectrum to obtain the actual sound pressure value, wherein the actual sound pressure value comprises sound pressure values of a plurality of positions.

In one embodiment, the updating module 308 is further configured for calculating an error value between the theoretical sound pressure value and the actual sound pressure value by an error function, wherein a formula of the error function is as follows:

$$E ( m ) = K {\sum }_{f = 1}^{F} In [ {B}^{f} ( m ) {\vert {p}_{mea}^{f} \vert}^{2} ] ;$$

wherein,

$${B}^{f} ( m ) = 1 - \frac{\vert {[ {p}_{FFM}^{f} ( m ) ]}^{*} {p}_{mea}^{f} {\vert}^{2}}{{\vert {p}_{mea}^{f} \vert}^{2} {\vert {p}_{FFM}^{f} ( m ) \vert}^{2}} ,$$

P_{FFM}^{f}(m) denotes the theoretical sound pressure value, Pₘₑₐ^{f} denotes the actual sound pressure value, and m denotes the parameter of the seabed model; * denotes conjugate transpose, f denotes a serial number of frequency points, F denotes a total number of frequency points used, and K denotes a number of hydrophones. When the error value is greater than a preset error value, the value of each geoacoustic parameter is updated and adjusted.

In one embodiment, the generating module 304 is further configured for acquiring an initial value of each geoacoustic parameter, wherein the initial value is randomly generated based on the preset change range; performing disturbance by using the improved simulated annealing method to generate the new value of each geoacoustic parameter based on the initial value of each geoacoustic parameter and the preset change range; and calculating to obtain a corresponding new theoretical sound pressure value according to the new value of each geoacoustic parameter. The updating module 308 is further configured for calculating to obtain a new error value according to the new theoretical sound pressure value and the actual sound pressure value, comparing the new error value with the previous error value, retaining a smaller error value and a corresponding geoacoustic parameter, re-executing the step of generating the new geoacoustic parameter value by performing disturbance based on the initial value of each geoacoustic parameter and the preset change range until a convergence condition is reached, and taking the theoretical sound pressure value corresponding to the value of each finally retained geoacoustic parameter as a sound pressure value matched with the actual sound pressure value.

In one embodiment, the generating module 304 is further configured for acquiring a current annealing temperature, and determining a disturbance coefficient according to the current annealing temperature; determining a disturbance amplitude according to the disturbance coefficient; acquiring a disturbance condition, wherein the disturbance condition is that middle and lower seabed parameters in the multilayer seabed models are larger than upper seabed parameters; and randomly generating the new value of each geoacoustic parameter according to the preset change range, the disturbance amplitude and the disturbance condition.

In one embodiment, the calculation module 310 is further configured for calculating to obtain the BIC value corresponding to each seabed model by the improved Bayesian theory according to the target geoacoustic parameter value corresponding to each seabed model and the error value, wherein the calculating of the BIC value is realized by the following formula:

BIC=2E(\hat{m})+M logₑ^{N}

wherein, M is a number of parameters in the model, N is a number of data, and E(\hat{m}) denotes an error value calculated according to an error function.

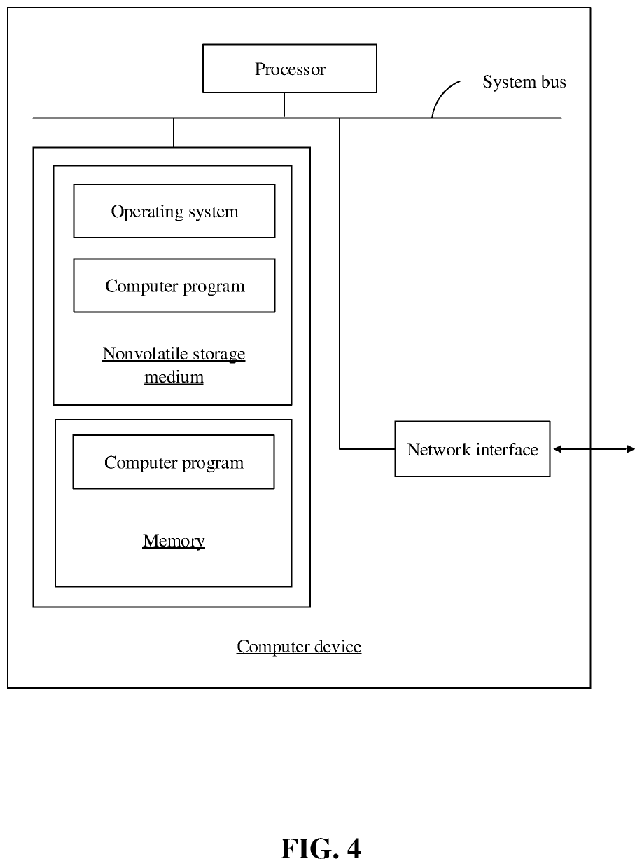

FIG. 4 illustrates an internal structure diagram of a computer device in one embodiment. The computer device may specifically be a terminal, or a server. As shown in FIG. 4, the computer device comprises a processor, a memory and a network interface connected via a system bus. The memory comprises a nonvolatile storage medium and an internal memory. The nonvolatile storage medium of the computer device stores an operating system, and may also store a computer program which, when being executed by the processor, enables the processor to implement the inversion method for the multilayer seabed geoacoustic parameter in the shallow sea mentioned above. The internal memory may also store a computer program which, when being executed by the processor, enables the processor to execute the inversion method for the multilayer seabed geoacoustic parameter in the shallow sea mentioned above. Those skilled in the art can understand that the structure shown in FIG. 4 is only a block diagram of some structures related to the solutions of the present application and does not constitute a limitation on the computer device to which the solutions of the present application is applied. The computer device may include more or fewer components than those shown in the figure, or may combine some components, or have different component arrangements.

In one embodiment, a computer device is provided, comprising a memory and a processor, wherein the memory stores a computer program, and the computer program, when being executed by the processor, enables the processor to execute the steps of the inversion method for the multilayer seabed geoacoustic parameter in the shallow sea mentioned above.

In one embodiment, a computer-readable storage medium is provided, storing a computer program which, when being executed by the processor, enables the processor to execute the steps of the inversion method for the multilayer seabed geoacoustic parameter in the shallow sea mentioned above.

Those of ordinary skills in the art can understand that all or a part of the flow of the methods in the above embodiments may be implemented by instructing relevant hardware through a computer program. The program may be stored in a nonvolatile computer-readable storage medium, and the program, when being executed, may include the flow of the above-mentioned method embodiments.

Any reference to the memory, storage, database or other media used in various embodiments provided by the present application may comprise nonvolatile and/or volatile memories. The nonvolatile memory may comprise a Read-only Memory (ROM), a Programmable ROM (PROM), an Electrically Programmable ROM (EPROM), an Electrically Erasable Programmable ROM (EEPROM), or a flash memory. The volatile memory may comprise a Random Access Memory (RAM) or an external cache memory. By way of illustration rather than limitation, the RAM is available in various forms, such as a Static RAM (SRAM), a Dynamic RAM (DRAM), a Synchronous DRAM (SDRAM), a Double Data Rate SDRAM (DDRSDRAM), an Enhanced SDRAM (ESDRAM), a Synchlink DRAM (SLDRAM), a Rambus Direct RAM (RDRAM), a Direct Rambus Dynamic RAM (DRDRAM), and a Rambus Dynamic RAM (RDRAM), and the like.

The technical features of the above embodiments can be combined in any way. In order to simplify the description, not all the possible combinations of the technical features of the above embodiments are described. However, as long as there is no contradiction in the combinations of these technical features, they should be considered as the scope recorded in this specification.

The above described embodiments merely represent several embodiments of the present application, and the descriptions thereof are more specific and detailed, but should not be understood as a limitation to the patent scope of the present application. It should be noted that those of ordinary skills in the art may make a plurality of decorations and improvements without departing from the conception of the present application, and these decorations and improvements shall all fall within the protection scope of the present application. Therefore, the protection scope of the patent according to the present application should be subjected to the claims appended.

What is claimed is:

1. An inversion method for a multilayer seabed geoacoustic parameter in a shallow sea, comprising:
establishing a plurality of seabed models, different seabed models corresponding to different layer numbers; according to a wave theory, constructing a displacement potential functional equation in a cylindrical coordinate corresponding to each layer in each seabed model, the displacement potential function of each layer being represented by a wave equation system in combination with a point source condition and a boundary condition at a fluid/elastomer interface under a sound field condition, and solving each coefficient of the wave equation system based on a Fast Field Method, thus obtaining the displacement potential function of each layer; the geoacoustic parameter in each layer of each seabed model being a parameter to be inverted, and the geoacoustic parameter of each layer comprising: a density, a shear sound velocity, a longitudinal sound velocity, a shear attenuation, a longitudinal attenuation and a seabed thickness;
respectively acquiring a preset change range corresponding to each geoacoustic parameter with respect to each seabed model, randomly generating a value of each geoacoustic parameter based on the preset change range corresponding to each geoacoustic parameter, and then calculating to obtain a theoretical sound pressure value based on the value of each geoacoustic parameter in combination with the displacement potential function of each layer of the seabed model;
acquiring an actual sound pressure value obtained by actual measurement;
comparing the theoretical sound pressure value with the actual sound pressure value, when the theoretical sound pressure value is not matched with the actual sound pressure value, using an improved simulated annealing method to perform disturbance to generate a new value of each geoacoustic parameter based on a current value of each geoacoustic parameter and the preset change range as a new current value of each geoacoustic parameter, re-performing calculation based on the new current value of each geoacoustic parameter to obtain a new theoretical sound pressure value, iteratively performing the step of comparing the new theoretical sound pressure value with the actual sound pressure value until the new theoretical sound pressure value is matched with the actual sound pressure value;
and when the new theoretical sound pressure value is matched with the actual sound pressure value, taking the new current value of each geoacoustic parameter as a target geoacoustic parameter value corresponding to the parameter to be inverted;
calculating to obtain a BIC value corresponding to each seabed model by a Bayesian theory according to the target geoacoustic parameter value corresponding to each seabed model; and
taking the seabed model with the minimum BIC value as a target seabed model, and taking a target geoacoustic parameter value corresponding to the target seabed model as a target inversion parameter value.

2. The method according to claim 1, wherein the step of acquiring the actual sound pressure value obtained by actual measurement, comprises:
using a hydrophone to monitor a sound wave emitted by a sound source, wherein the sound wave is generated by transmitting in water by a transmitting transducer, and the hydrophone and the transmitting transducer complete the measurement by relative movement;
importing an audio in way format detected by the hydrophone into matlab and converting the audio into one set of numerical values;
processing the one set of numerical values by Fourier transform to obtain a frequency spectrum corresponding to the one set of numerical values; and
calculating an amplitude of the frequency spectrum to obtain the actual sound pressure value, wherein the actual sound pressure value comprises sound pressure values of a plurality of positions.

3. The method according to claim 1, wherein the step of comparing the theoretical sound pressure value with the actual sound pressure value, comprises:
calculating an error value between the theoretical sound pressure value and the actual sound pressure value by an error function, wherein a formula of the error function is as follows:
$$E ( m ) = K {\sum }_{f = 1}^{F} In [ {B}^{f} ( m ) {\vert {p}_{mea}^{f} \vert}^{2} ] ;$$
wherein,
$${B}^{f} ( m ) = 1 - \frac{\vert {[ {p}_{FFM}^{f} ( m ) ]}^{*} {p}_{mea}^{f} {\vert}^{2}}{{\vert {p}_{mea}^{f} \vert}^{2} {\vert {p}_{FFM}^{f} ( m ) \vert}^{2}} ,$$
P_{FFM}^{f}(m) denotes the theoretical sound pressure value, Pₘₑₐ^{f} denotes the actual sound pressure value, and m denotes the parameter of the seabed model; * denotes conjugate transpose, f denotes a serial number of frequency points, F denotes a total number of frequency points used, and K denotes a number of hydrophones; and
when the error value is greater than a preset error value, the theoretical sound pressure value is not matched with the actual sound pressure value; and when the error value is less than or equal to the preset error value, the theoretical sound pressure value is matched with the actual sound pressure value.

4. The method according to claim 1, wherein, the step of using the improved simulated annealing method to perform disturbance to generate the new value of each geoacoustic parameter based on the current value of each geoacoustic parameter and the preset change range as the new current value of each geoacoustic parameter, comprises:
acquiring a current number of iterations, and determining a disturbance coefficient according to the current number of iterations; setting a disturbance condition being that middle and lower seabed parameters in the multilayer seabed models are larger than upper seabed parameters; and generating the new current value of each geoacoustic parameter based on the current value of each geoacoustic parameter in combination with the preset change range, the disturbance coefficient and the disturbance condition.

5. The method according to claim 1, wherein the step of, calculating to obtain the BIC value corresponding to each seabed model by the Bayesian theory according to the target geoacoustic parameter value corresponding to each seabed model, comprises:
calculating to obtain the BIC value corresponding to each seabed model by the Bayesian theory according to the target geoacoustic parameter value corresponding to each seabed model and the error value, wherein the calculating of the BIC value is realized by the following formula:
BIC=2E(\hat{m})+M logₑ^{N}
wherein, M is a number of parameters in the model, N is a number of data, and E(\hat{m}) denotes an error value calculated according to an error function.

6. An inversion apparatus for a multilayer seabed geoacoustic parameter in a shallow sea, comprising:
an establishing module, configured for establishing a plurality of seabed models, different seabed models corresponding to different layer numbers; according to a wave theory, constructing displacement potential functional equations in cylindrical coordinates corresponding to each layer in each seabed model, the displacement potential function of each layer being represented by a wave equation system in combination with a point source condition and a boundary condition at a fluid/elastomer interface under a sound field condition, and solving each coefficient of the wave equation system based on a Fast Field Method, thus obtaining the displacement potential function of each layer; the geoacoustic parameter in each layer of each seabed model being a parameter to be inverted, and the geoacoustic parameter of each layer comprising: a density, a shear sound velocity, a longitudinal sound velocity, a shear attenuation, a longitudinal attenuation and a seabed thickness;
a generating module, configured for respectively acquiring a preset change range corresponding to each geoacoustic parameter with respect to each seabed model, randomly generating a value of each geoacoustic parameter based on the preset change range corresponding to each geoacoustic parameter, and then calculating to obtain a theoretical sound pressure value based on the value of each geoacoustic parameter in combination with the displacement potential function of each layer of the seabed model;
an acquisition module, configured for acquiring an actual sound pressure value obtained by actual measurement;
an updating module, configured for comparing the theoretical sound pressure value with the actual sound pressure value, when the theoretical sound pressure value is not matched with the actual sound pressure value, using an improved simulated annealing method to perform disturbance to generate a new value of each geoacoustic parameter based on a current value of each geoacoustic parameter and the preset change range as a new current value of each geoacoustic parameter, re-performing calculation based on the new current value of each geoacoustic parameter to obtain a new theoretical sound pressure value, iteratively performing the step of comparing the new theoretical sound pressure value with the actual sound pressure value until the new theoretical sound pressure value is matched with the actual sound pressure value; and when the new theoretical sound pressure value is matched with the actual sound pressure value, taking the new current value of each geoacoustic parameter as a target geoacoustic parameter value corresponding to the parameter to be inverted;
a calculation module, configured for calculating to obtain a BIC value corresponding to each seabed model by a Bayesian theory according to the target geoacoustic parameter value corresponding to each seabed model; and
a determining module, configured for taking the seabed model with the minimum BIC value as a target seabed model, and taking a target geoacoustic parameter value corresponding to the target seabed model as a target inversion parameter value.

7. A computer-readable storage medium storing a computer program, wherein the computer program, when being executed by a processor, enables the processor to execute the steps of the inversion method for the multilayer seabed geoacoustic parameter in the shallow sea according to claim 1.

8. A computer device comprising a memory and a processor, wherein the memory stores a computer program which, when being executed by the processor, enables the processor to execute the steps of the inversion method for the multilayer seabed geoacoustic parameter in the shallow sea according to claim 1.
